(19) United States
(12) Patent Application Publication
(10) Pub. No.: US 2012/0197676 A1
(43) Pub. Date: Aug. 2, 2012

(54) EVALUATING OPERATIONAL MATURITY OF BUSINESS COMMODITIES

(75) Inventor: Philip B. Edwards, Charlotte, NC (US)

(73) Assignee: BANK OF AMERICA CORPORATION, Charlotte, NC (US)

(21) Appl. No.: 13/017,957

(22) Filed: Jan. 31, 2011

(51) Int. Cl. G06Q 10/00

(52) U.S. Cl. 705/7.12

(57) ABSTRACT

Systems, methods, and computer program products for evaluating the operational maturity of business commodities are disclosed. An operational maturity score is computed and based, at least in part, on documentation data relating to operational documents of the business commodities. A determination of the maturity lifecycle stage of the commodity may also be made. If desired, with operational maturity scores and/or maturity lifecycle stage determinations of multiple business commodities, comparison data may be produced to conveniently compare the operational maturity of a plurality of business commodities.

### FIELD

In general, embodiments of the invention relate to systems, methods and computer program products for business management and, more particularly, evaluating the operational maturity of business commodities.

### BACKGROUND

Great lengths are often taken to identify programs, products, services, or operational functions and duties within a business, which may be implemented or improved, through the use of process analysis and other business tools. Furthermore, after programs are implemented the health, stability, and effectiveness of the programs are often tracked and measured for analysis of their performance and operational growth or maturity. However, business leaders often find it difficult to properly assess the maturity of a program or commodity with respect to other programs within the business due to fundamental differences in the operations. For example, a business leader may encounter complications in attempting to assess the efficiency or maturity of an internal business operation such as copy centers as compared to a commodity such as corporate automobiles. Conversely, business leaders may find it increasingly difficult to assess what internal programs yield an acceptable level of operational maturity and what programs need additional resources committed to improve their level of operational maturity and therefore balancing an acceptable risk to reward objective.

Furthermore, without the capability of comparison of business commodities across many different lines of business, it is often very difficult for business leaders to identify operational maturity problems or opportunities. For example, an immature business commodity that is not managed properly, does not have the appropriate and applicable documentation on file, does not have defined strategic visions, etc., and yet may be functioning at a high level of efficiency and not raise any alarms to the business leaders. However, the commodity's immaturity would likely lead to numerous problems in the future; for example process failures, loss of revenue, increased risk, quality defects, poor expense management and/or an inability to provide documentation for operational business assessments including audits; all of which could have been addressed had business leaders been aware of heightened risk factors for problems due to operational immaturity. Additionally, the capability to review, assess and compare commodity maturity levels across diverse topical areas allows for cross functional identification of opportunities that can expedite, increase or otherwise improve the efficiency, stability and maturity level of less mature commodities.

Thus, there is a need to develop a system that is capable of providing business leaders a business tool that is capable of providing a quantifiable measurement of the operational maturity of business commodities when comparing the operational maturity of numerous commodities.

### SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention relate to systems, computer program products, and methods for evaluating the operational maturity of business commodities. Moreover, embodiments of the present invention provide for a business tool capable of determining an operational maturity score for one or more business commodities. The maturity score can be based, at least in part, on documentation data of the commodity. The user may also include a subjective determination of the maturity lifecycle stage of the commodity. Such a determination may be useful in determining the significance of the maturity score. For instance, business leaders may find a maturity score acceptable for a business commodity that is in an early lifecycle stage such as, for example, a development stage, while the same score for a commodity in a later lifecycle stage such as, for example, a mature stage, could be alarming to the business leaders. The term “maturity score” may mean a quantifiable score or a model that is indicative of the commodity's maturity.

In a first embodiment of the invention, a system for evaluating operational maturity of business commodities is provided. The system includes a user interface, a memory device, a communication device, and a processor operatively coupled to the communication device, user interface, and memory device. The processor is configured to execute a computer-readable program code to receive documentation data associated with operational documents for a business commodity. The processor is further configured to execute a computer-readable program code to compute an operational maturity score for the business commodity based at least in part on the documentation data. Additionally, the processor is configured to execute a computer-readable program code to receive maturity lifecycle stage data for the business commodity.

In a specific embodiment, the system further comprises a business computer system. In some embodiments, the processor is further configured to execute the computer-readable program code to automatically receive the documentation data from a business computer system. In still further specific embodiments, the processor may be further configured to execute the computer-readable program code to automatically recompute the operational maturity score for the business commodity when operational documents are updated or otherwise altered thus altering the documentation data. In some embodiments, the operational maturity score is updated in real time as operational documents are updated or otherwise altered.

In another specific embodiment of the system, the processor is further configured to execute the computer-readable program code to manually receive the documentation data as inputted by a system user.

In some specific embodiments of the system, the documentation data includes data indicating whether one or more operational documents relating to the business commodity have been created, are under development, have not been created, or are not applicable to the particular business commodity.

In other specific embodiments of the system, the operational documents comprise core required documents. In some embodiments, the documentation data relating to one or more of the core required documents is weighed more in the computation of the operational maturity score than other factors that may contribute to the operational maturity score computation.

In another specific embodiment of the system, the processor is further configured to execute the computer-readable program code to receive information inputted by a user. The information relates to business commodity. In some embodiments, the information inputted by a user includes a summary or overview of the business commodity, a strategic plan for the business commodity going forward, important critical-to-quality procedures for the business commodity, or combinations thereof.

In still a further embodiment of the system, the maturity lifecycle stage data is a subjective determination determined and inputted by a user.

In some specific embodiments of the system, the processor is further configured to execute the computer-readable program code to generate comparison data to compare the operational maturity of a plurality of business commodities. In some embodiments, the comparison data is a chart or graph that includes maturity lifecycle stage data and/or the operational maturity score for each business commodity.

Moreover, in some specific embodiments of the system, the documentation data further includes additional data. The additional data is selected from the group consisting of data indicating the last time one or more operational documents was updated, data indicating the version of one or more operational documents, data indicating whether one or more documents are applicable for the business commodity, data indicating the quality of the information within one or more operational documents, and combinations thereof. In some embodiments, the additional data comprises data indicating the quality of the information within one or more operational documents, the quality being determined by the presence or absence of predetermined key words within or phrases within one or more operational documents, the amount of information within one or more operational documents, or file sizes of one or more operational documents.

In another aspect of the invention, a computer program for evaluating the operational maturity of business commodities is provided. The computer program product includes at least one computer-readable medium having computer-readable program code portions embodied therein. The computer-readable program code portions include a first executable portion configured for receiving, through the use of a processor, documentation data associated with operational documents for a business commodity. The processor is operatively coupled to the computer-readable program code, a user interface, a memory device, and a communication device. The computer-readable program code further comprises a second executable portion configured for computing, through the use of the processor, an operational maturity score for the business commodity. The operational maturity score is based at least in part on the documentation data. The computer-readable program code further includes a third executable portion configured for receiving, through the use of the processor, maturity lifecycle stage data for the business commodity.

In a specific embodiment of the computer program product, the first executable portion is further configured to automatically receive the documentation data from a business computer system. In some embodiments, the first executable portion is further configured to automatically recompute the operational maturity score for the business commodity when operational documents are updated or otherwise altered thus altering the documentation data. In some embodiments, the operational maturity score is updated in real time as operational documents are updated or otherwise altered.

In another specific embodiment of the computer program product, the first executable portion is further configured to manually receive the documentation data as inputted by a system user.

In still another specific embodiment of the computer program product, the documentation data includes data on whether one or more operational documents relating to the business commodity have been created, are under development, have not been created, or are not applicable to the particular business commodity.

In another specific embodiment of the computer program product, the operational documents include core required documents. In some embodiments, the second executable portion is further configured to weigh one or more of the core required documents more in the computation of the operational maturity score than other factors that may contribute to the operational maturity score computation.

In some specific embodiments of the computer program product, the product further includes a fourth executable portion configured to receive information inputted by a user, the information relating to the business commodity. In some embodiments, the information inputted by a user includes a summary or overview of the business commodity, a strategic plan for the business commodity going forward, important critical-to-quality procedures for the business commodity, or combinations thereof.

In still further specific embodiments of the computer program product, the maturity lifecycle stage data is a subjective determination determined and inputted by a user.

Moreover, in some specific embodiments of the computer program product, the product further comprises a fifth executable portion configured to generate comparison data to compare the operational maturity of a plurality of business commodities. In some embodiments, the comparison data is a chart or graph that includes maturity lifecycle stage data and/or the operational maturity score for each business commodity.

In another specific embodiment of the computer program product, the documentation data further includes additional data. The additional data is selected from the group consisting of data indicating the last time one or more operational documents was updated, data indicating the version of one or more operational documents, data indicating whether one or more documents are applicable for the business commodity, data indicating the quality of the information within one or more operational documents, and combinations thereof. In some embodiments, the additional data comprises data indicating the quality of the information within one or more operational documents. The quality may be determined by the presence or absence of predetermined key words or phrases within one or more operational documents, the amount of information within one or more operational documents, or file sizes of one or more operational documents.

In still a further aspect of the present invention, a method for evaluating the operational maturity of business commodities is provided. The method includes receiving, via a computing device processor, documentation data associated with operational documents for a business commodity. The method further includes computing, via the computing device processor, an operational maturity score for the business commodity based at least in part on the documentation data. Additionally, the method includes receiving, via the computing device processor, maturity lifecycle stage data for the business commodity.

In some specific embodiments of the method, the documentation data is automatically received from a business computer system. In some embodiments, the method further includes automatically recomputing the operational maturity score for the business commodity when operational documents are updated or otherwise altered thus altering the documentation data. In still further embodiments, the operational maturity score is updated in real time as operational documents are updated or otherwise altered.

In other specific embodiments of the method, the documentation data is manually inputted by a system user.

In some specific embodiments of the method, the documentation data includes data on whether one or more operational documents relating to the business commodity have been created, are under development, have not been created, or are not applicable to the particular business commodity.

In another specific embodiment of the method, the operational documents comprise core required documents. In some embodiments, the documentation data relating to one or more of the core required documents is weighed more in the computation of the operational maturity score than other factors that may contribute to the operational maturity score computation.

In other specific embodiments, the method further includes receiving information inputted by a user where the information relates to the business commodity. In some embodiments, the information inputted by a user includes a summary or overview of the business commodity, a strategic plan for the business commodity going forward, important critical-to-quality procedures for the business commodity, or combinations thereof.

Moreover, in another specific embodiment of the method, the maturity lifecycle stage data is a subjective determination determined and inputted by a user.

In some specific embodiments, the method further includes generating comparison data to compare the operational maturity of a plurality of business commodities. In some embodiments, the comparison data is a chart or graph that includes the maturity lifecycle stage data and/or the operational maturity score for each business commodity.

In still further specific embodiments of the method, the documentation data further includes additional data, the additional data selected from the group consisting of data indicating the last time one or more operational documents was updated, data indicating the version of one or more operational documents, data indicating whether one or more documents are applicable for the business commodity, data indicating the quality of the information within one or more operational documents, and combinations thereof. In some embodiments, the additional data includes data indicating the quality of the information within one or more operational documents. The quality is determined by the presence or absence of predetermined key words or phrases within one or more operational documents, the amount of information within one or more operational documents, or file sizes of one or more operational documents.

Thus, further details are provided below for systems, computer program products, and methods for evaluating the operational maturity of business commodities. An operational maturity score for one or more business commodities is computed. The operational maturity score can be based, at least in part, on documentation data of the commodity. The user may also include a subjective determination of the maturity lifecycle stage of the commodity. With the operational maturity score and the maturity lifecycle stage, the user may compare the determined values for a plurality of business commodities and evaluate the operational maturity of each commodity compared to other commodities.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Reference will now be made to the accompanying drawings, which are not necessarily drawn to scale, and wherein:

FIG. 1 is a block diagram of a system for evaluating the operational maturity of business commodities, in accordance with an embodiment of the present invention;

FIG. 2 illustrates an operational maturity template, in accordance with embodiments of the present invention;

FIG. 3 illustrates a Stakeholder Analysis template, in accordance with embodiments of the present invention;

FIGS. 4A-4B illustrates a Commodity Dashboard, in accordance with embodiments of the present invention;

FIG. 5 is a block diagram illustrating a Critical to Quality (CTQ) Operational Process Flow, in accordance with embodiments of the present invention;

FIGS. 6A-6B illustrates an Operational Risk Profile template, in accordance with an embodiment of the present invention;

FIG. 7 illustrates a Failure Mode and Effects Analysis (FMEA) template, in accordance with an embodiment of the present invention;

FIG. 8 is a block diagram illustrating a Team Organizational Chart, in accordance with embodiments of the present invention;

FIG. 9 illustrates a VOC/VOA template that helps determine the voice of the customer and critical to quality metrics in accordance with an embodiment of the present invention.

FIG. 10 illustrates an operational maturity template, in accordance with embodiments of the present invention;

FIGS. 11A-11C illustrates a sample chart comparing maturity lifecycle stage data and operational maturity scores for a plurality of business commodities, in accordance with an embodiment of the present invention.

FIG. 12 is a flow diagram of a method for evaluating the operational maturity of business commodities, in accordance with an embodiment of the present invention; and

FIG. 13 is a flow diagram of a method for evaluating the operational maturity of business commodities, in accordance with an embodiment of the present invention;

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments of the present invention, the functions described may be implemented in hardware, software, firmware, or any combination thereof. If implemented in software, the functions may be stored or transmitted as one or more instructions or code on a computer-readable medium. Computer-readable media includes both computer storage media and communication media, including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

In general, embodiments of the present invention relate to systems, computer program products, and methods for evaluating the operational maturity of business commodities. Moreover, embodiments of the present invention provide for a business tool capable of determining an operational maturity score for one or more business commodities. The maturity score can be based, at least in part, on documentation data of the commodity. The user may also include a subjective determination of the maturity lifecycle stage of the commodity. In some embodiments, a plurality of operational maturity scores and/or maturity lifecycle stages for various business commodities may be compared in some form, such as a graph or a chart. Such a comparison provides a valuable tool to business leaders to assess the operational maturity of numerous business commodities across multiple lines of business.

For the purposes of this invention, a “financial institution” is defined as any organization in the business of moving, investing, or lending money, dealing in financial instruments, or providing financial services. This includes commercial banks, thrifts, federal and state savings banks, savings and loan associations, credit unions, investment companies, insurance companies and the like. A “business leader” is defined as an individual or group of individuals who are considered corporate leaders or corporate management and/or are, at least in part, responsible for overseeing one or more business commodities. A “user” is defined as any employee of the business or an independent contractor contracted by the business. A user will typically be a supervisor or manager of one or more business commodities. A “commodity” or “commodities” is defined as programs, products, services, operational functions, duties, etc. within a business.

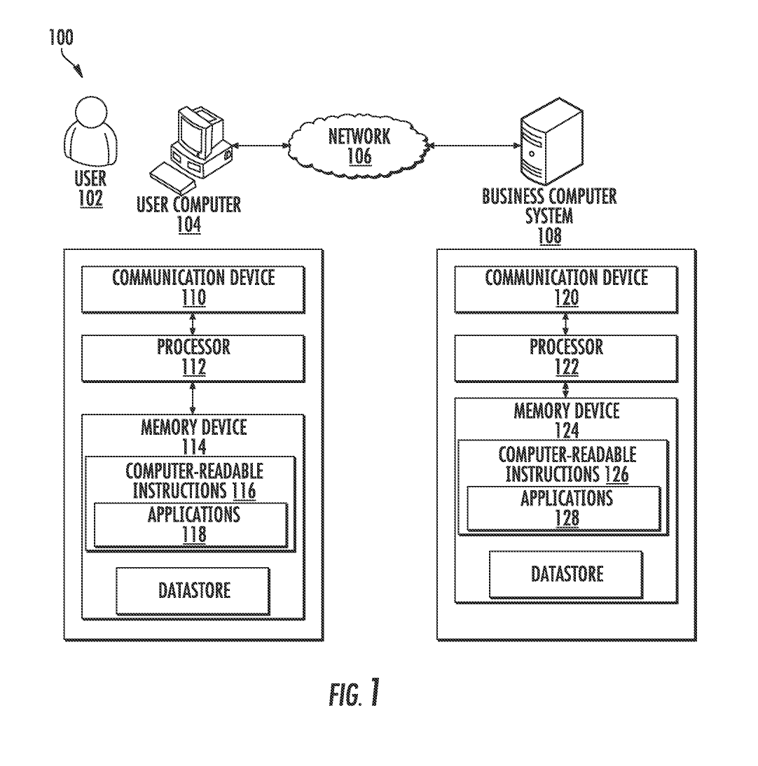

Referring to FIG. 1, a block diagram of a general system 100 for evaluating the operational maturity of business commodities is illustrated. As illustrated, a user 102 may utilize an interface, such as a computer 104 to communicate with a network 106 and a business computer system 108. The user computer 104 may be a typical computer housing a communication device 110, a processor 112, and a memory device 114. Typically, the memory device 114 includes computer-readable instructions 116 for applications 118. Similarly, the business computer system 108 also generally includes a communication device 120, a processor 112 and a memory device 124 that includes computer-readable instructions 126 for applications 128.

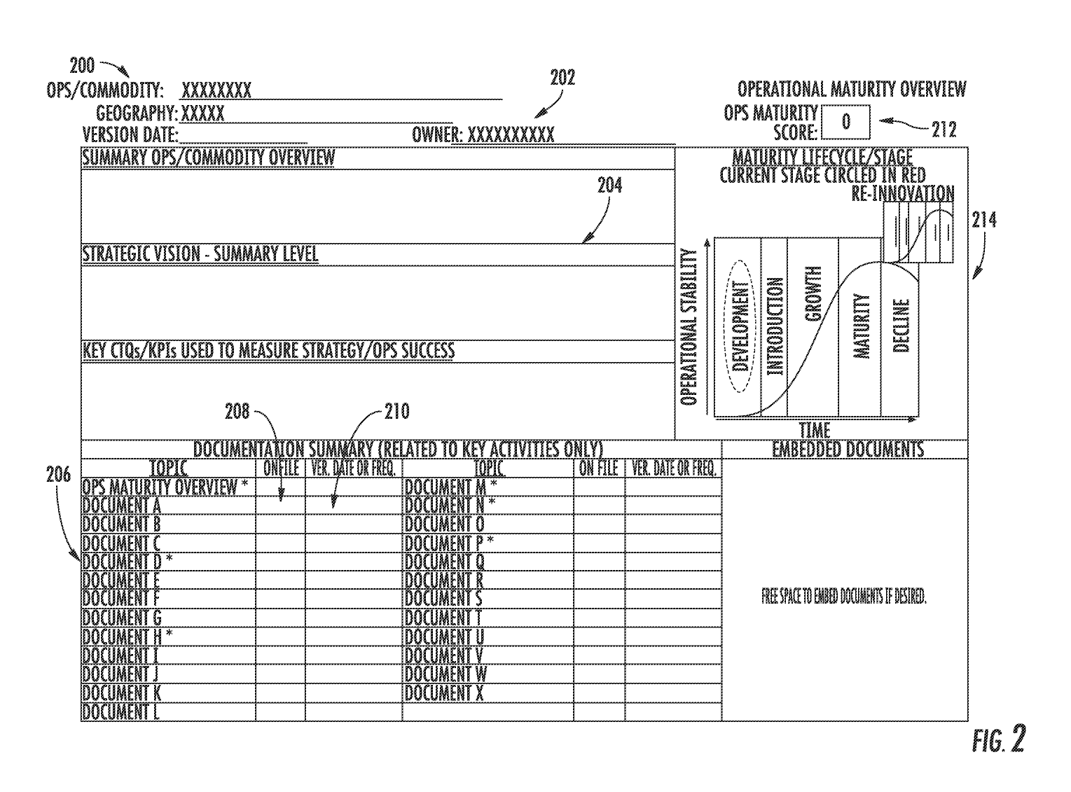

Turning to FIG. 2, an operational maturity template 200 is illustrated. A template 200 as illustrated, or its functional equivalent, illustrates one embodiment of an application that may be utilized to generate an operational maturity score 212 for business commodities. Generally, the template 200 may include some identifying data 202 of the business commodity. The identifying data 202 can include the name of the commodity, geography (i.e., where within the business is the commodity implemented), and other information such as the date and user's name that completed the template.

The template 200 may further include summary data 204 that a user 102 may input. Such summary data may include information such as a brief summary or overview of the business commodity and its functions, a strategic plan for the business commodity going forward, important critical-to-quality (CTQ) procedures and/or key-performance-indicators (KPI) for the commodity, etc. This type of information could be very useful to a business leader that wishes to evaluate a business commodity as a host of information on the commodity may be stored and easily viewed along with the operational maturity score 212.

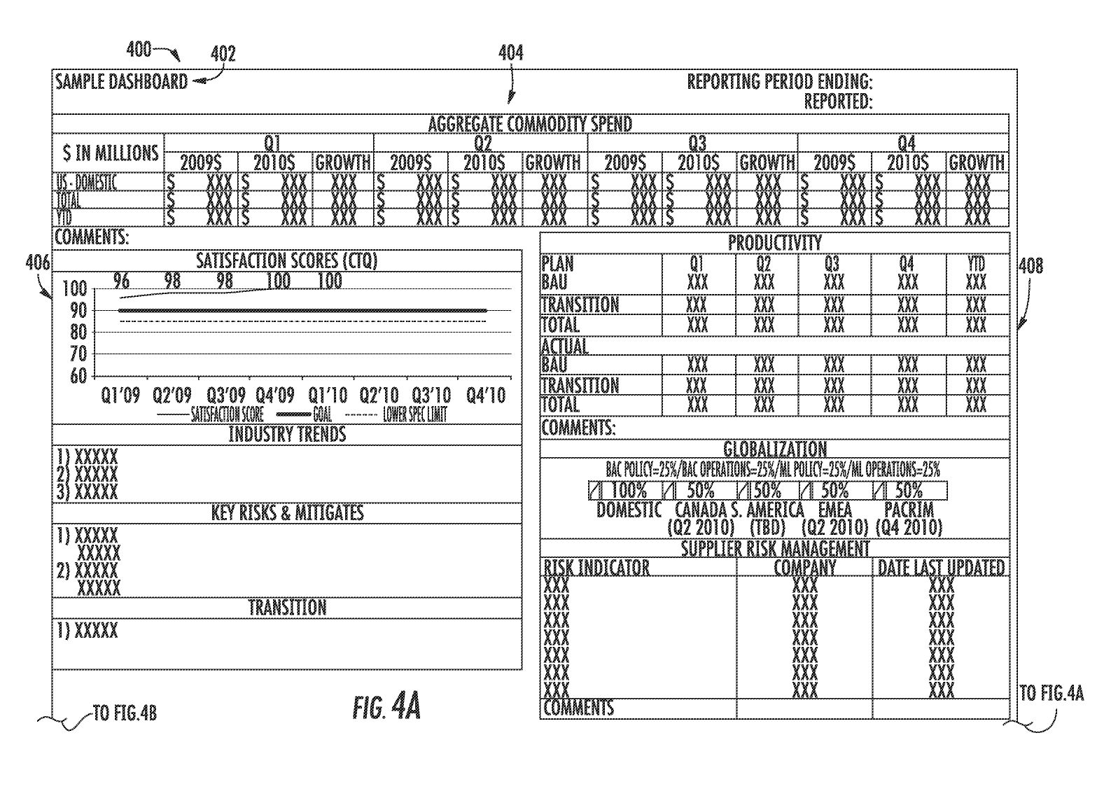

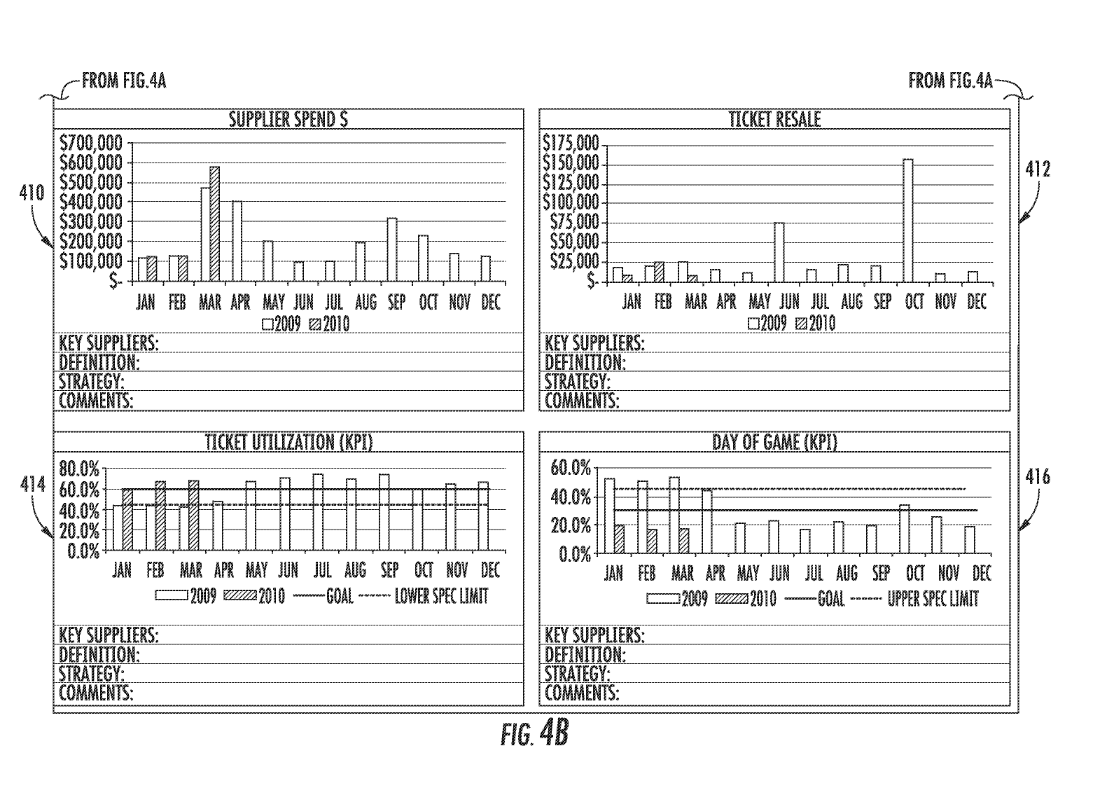

The operational maturity score 212 may factor in numerous measures within the business commodity. The measures that are important to a business commodity may vary significantly across different types of businesses and possibly within different lines of business for the same entity. However, typically, the operational maturity score will depend heavily on documentation data. Documentation data includes operational documents, reviews, plans, routines, etc. that are completed in the course of business. Documentation data may include seemingly minor data such as an organizational chart for the commodity to higher level documents and routines such as an operational dashboard or performance scorecard, an example of which is illustrated in FIGS. 4A-4B and discussed further below.

Documentation data typically includes a number of core documents that are generally mandatory (by internal policies or regulations) for all business commodities within the business. Such documentation will obviously vary depending upon the business implementing the system of the present invention. For instance, a core document could be similar to the operational maturity template 200 illustrated in FIG. 2. As shown in FIG. 2, other operational documents 206 are indicated generally as “Document A,” “Document B,” etc. In this embodiment, in addition to the operational maturity template 200, “Document D,” “Document H,” “Document M,” “Document N,” and “Document P” are considered core required documents as indicated by the “*”.

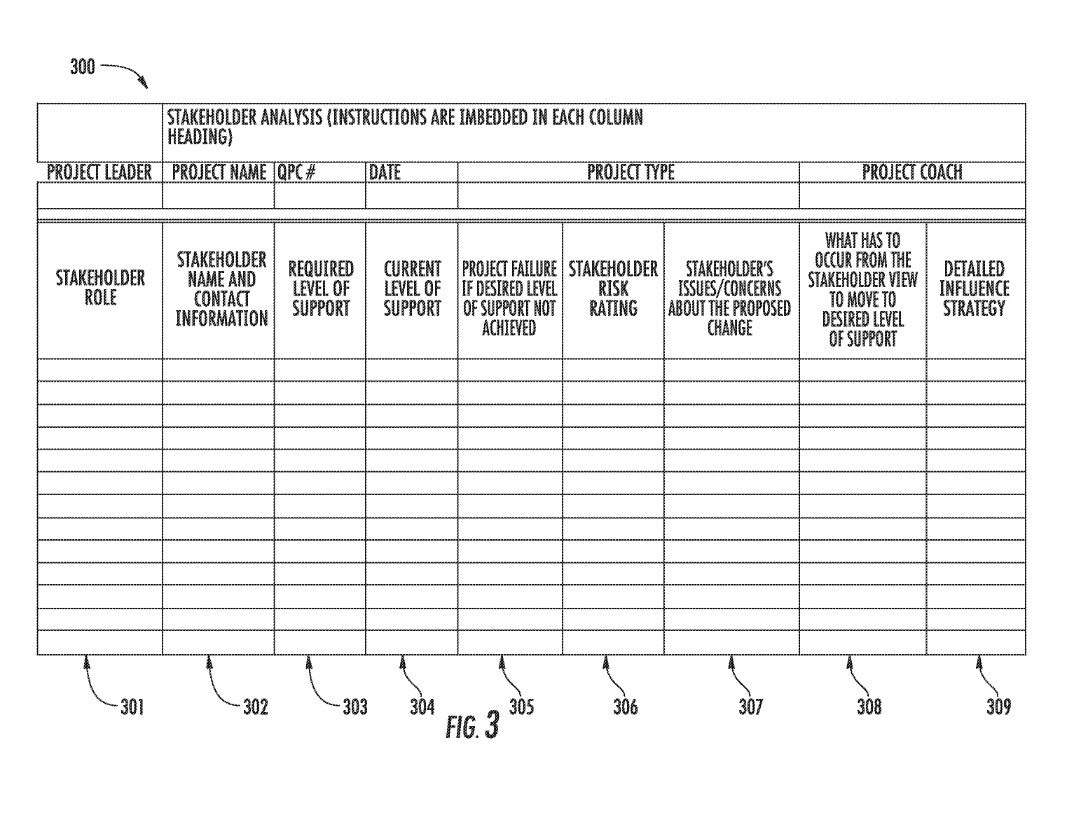

While, again, core documents, or indeed all documentation data, is highly dependant upon the type of business and the type of data considered to be important to commodities, without intending to be limited by the following examples, FIGS. 3-9 illustrate the type of documentation data that could be deemed as important for a business, in particular, a financial institution.

FIG. 3 illustrates a sample stakeholder analysis 300. Such an analysis may be completed indicating each stakeholder's role 301, their contact information 302, the level of required support 303 and current support 304, the failure 305 and risk 306 to the commodity if the desired support level is not reached, any issues that the stakeholder has expressed 307, the needs of the stakeholder to move to the desired level of support 308, and the strategy for influencing the stakeholder to provide the desired level of support 309.

FIGS. 4A-4B illustrate a sample “dashboard” 400 for a general commodity. For, in particular, financial institutions, operational dashboards 400 are typically a good way to monitor, measure, and report on informational metrics important to the operational commodity. Typically the dashboard 400 would be a key document that houses important information for business leaders to easily access. Such information could include identifying information 402 such as the commodity title, reporting period information, commodity supervisors, etc., financial information 404, CTQ satisfaction scores 406, productivity data 408, other associated costs 410, other associated revenue 412, and performance and strategy data 414 and 416. A dashboard 400 may, and often is, differ greatly between commodities, as each commodity may have vastly different functions and goals.

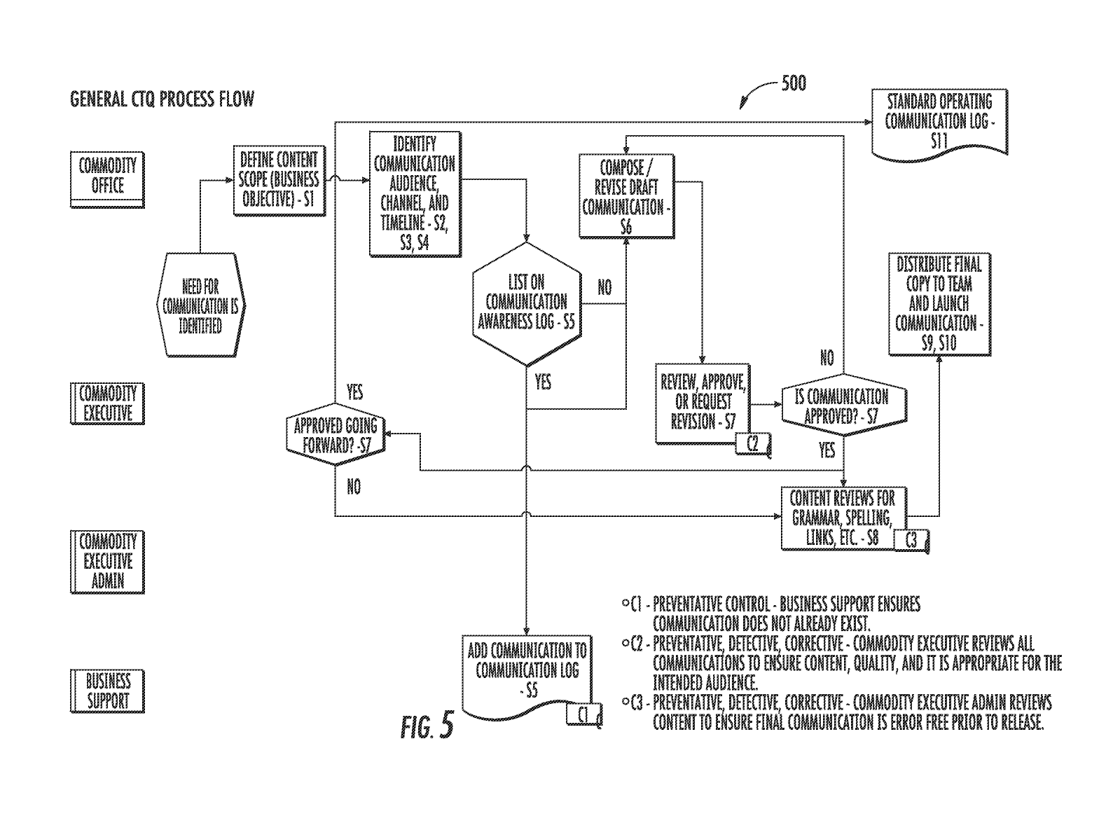

FIG. 5 illustrates a general CTQ Operational Process Flow 500. Such process flows can exist in multiple formats and files depending on the source system used to create them, creator expertise level, and level of process detail applicable to the commodity. For instance, CTQ process flows can represent an end-to-end procedure for products being delivered, ordered, paid for, produced, information flowing from one source to another system/source and/or instructional procedural documents explaining how an aggregate data element was collected and/or calculated, etc. The number of process flows for CTQ operational activities generally vary for each commodity.

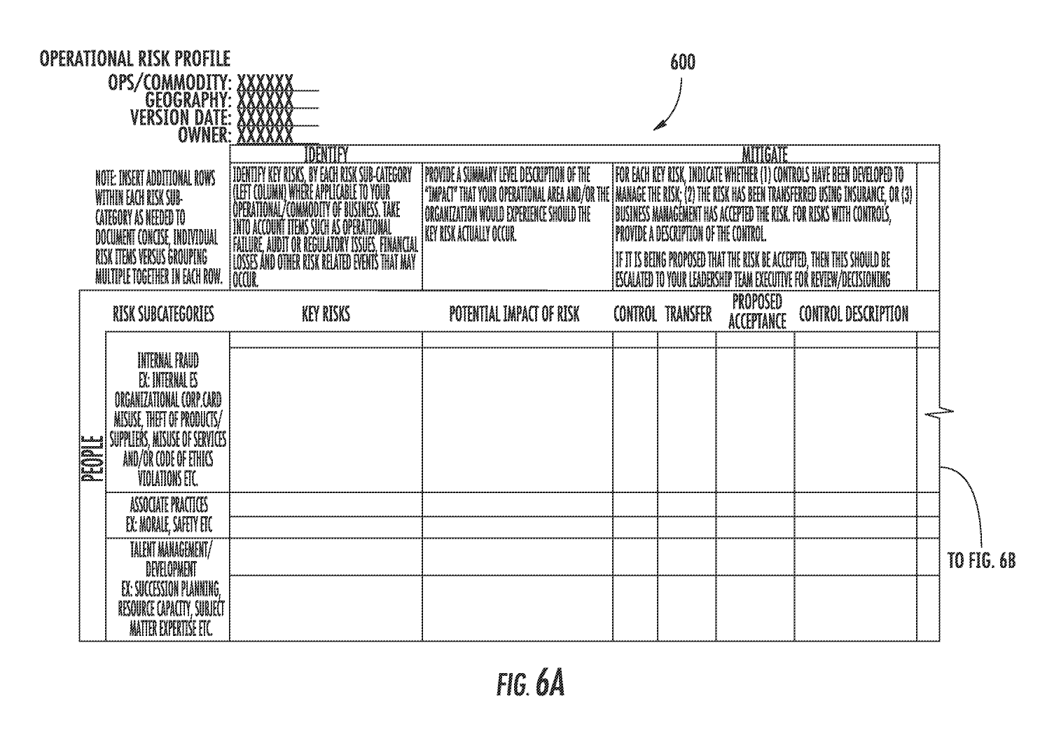

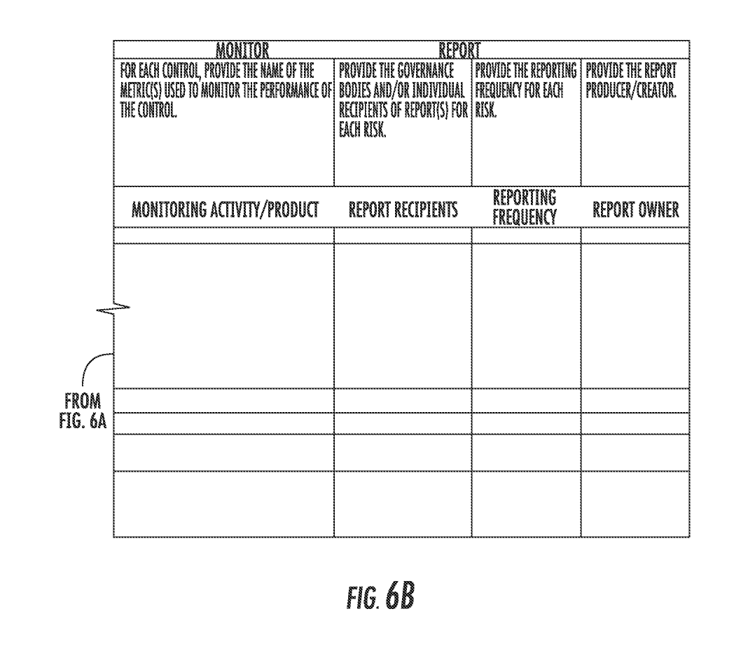

FIGS. 6A-6B illustrate an Operational Risk Profile template 600. The risk profile 600 helps reflect existing and inherent risks within the commodity function. For example, for financial institutions in particular, typical categories for “risk” center on people, systems, processes, external events, etc. Such a document could be helpful to the optimal functioning of a commodity and thus lead to a higher “operational maturity” level. For instance, in the sample template 600, it is seen that the user or creator of the template is tasked with identifying key risks and potential impacts, mitigating, monitoring, and reporting.

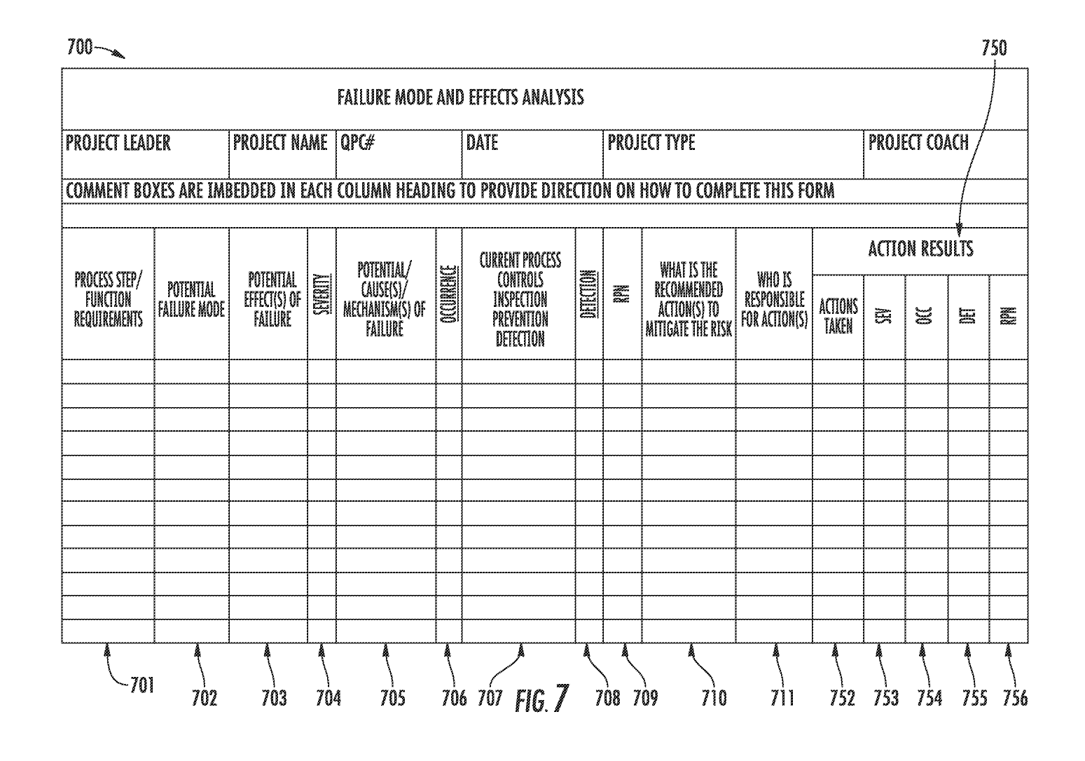

FIG. 7 illustrates a Failure Mode and Effects Analysis (“FMEA”) 700. Similar to the Operational Risk Profile template of FIGS. 6A-6B, such an analysis 700 may help identify the risks in the commodity. The FMEA should generally reflect the current failure modes that exist in the commodity. In this sample FMEA 700 shown, the analysis is directed toward a process. However, the FMEA could reflect a system, operational dependency, or other type of failure that may occur outside of a process itself. In the example FMEA 700, required is a listing all of the steps in the process 701, the potential failure modes 702 for each step, potential effects of a failure 703, and the severity 704 of the failure ranked from 1 being no effect to 5 being the loss of the customer. The FMEA template 700 also identifies potential root causes of the failure 705, the likelihood of occurrence 706 again ranked from 1—remote to 5—very high, the current process controls 707, the detection 708 of the failure before it impacts the customer ranked from 1—certain detection to 5—little or no chance of detection, and the RPN value 709. The RPN or Risk Priority Number equals the multiplication of the severity 704, the occurrence 706, and the detection 708 values. If this embodiment, if a value is greater than, for example 30, or if the severity is 5, then a detailed failure reaction plan would necessary. This plan is summarized in the FMEA indicating the recommended actions 710 and who is responsible for the action 711. The Action results section 750 is completed after mitigating actions have been taken.

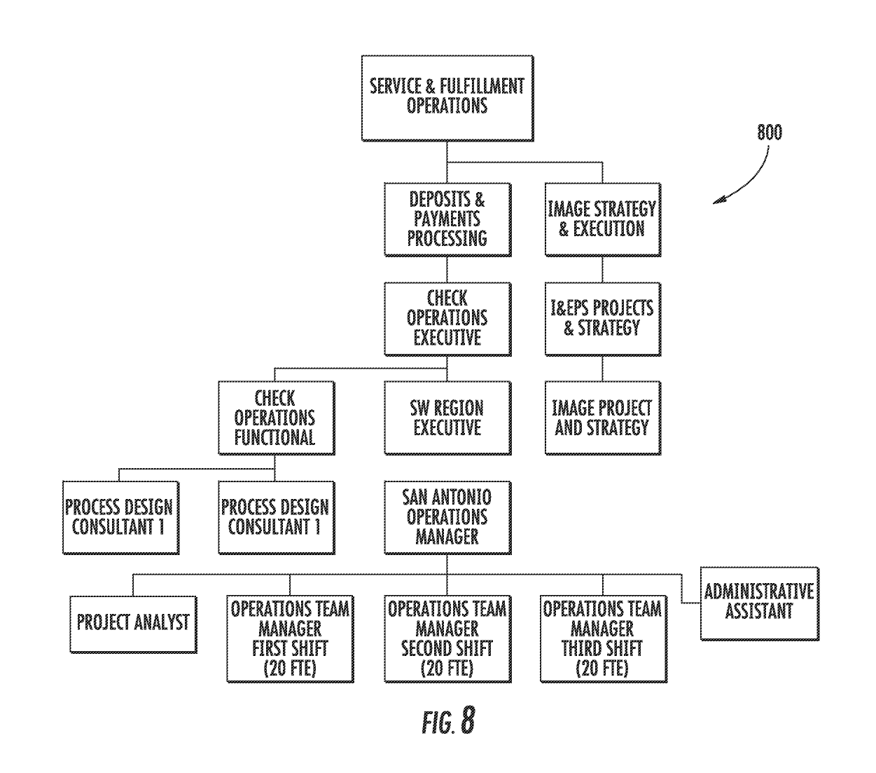

FIG. 8 illustrates an example commodity Team Organization Chart 800. Such a chart 800 may be utilized to formally indicate the roles and responsibilities of each member of the team and how the team is structured.

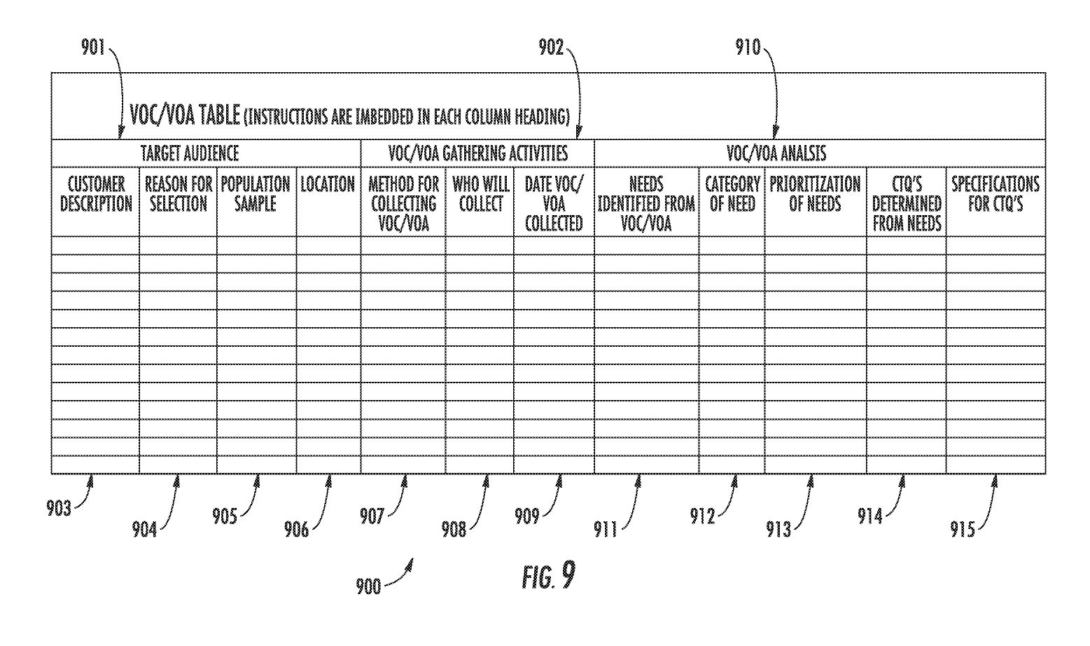

FIG. 9 illustrates an example “Voice of the Customer” and/or “Voice of the Associate” VOC/VOA 900 document that may be pertinent to particular commodities. To help define the VOC, the commodity team may complete, for example, the VOC/VOA template 900. The VOC/VOA template 900 includes categories for the target audience 901, VOC/VOA Gathering Activities 902, and the VOC/VOA Analysis 910. The target audience 901 includes listing the customer description 903, the reason for selecting that customer 904, the population sample 905, and location of the customer 906. The VOC/VOA Gathering Activities 902 includes listing the method of collecting the VOC information 907, who will collect 908, and date collected 909. The VOC/VOA Analysis 910 includes listing what are the identified needs from the collection 911, the category of the need 912, prioritization of the needs 913, what CTQs relate to the needs 914, and the specifications for the improved value of the CTQ 915.

FIGS. 3-9 are merely examples of the type of documentation data that may be pertinent to a business commodity. Some or all of the example operational documents in FIGS. 3-9 may be denoted as “core” required documents that provide necessary data to business leaders. For instance, in one embodiment, core required documents include the operational maturity template 200, stakeholder analysis 300, CTQ dashboard, 400, CTQ operational process flows 500, operational risk profile 600, and operational FMEA 700.

Returning to FIG. 2, as illustrated the operational maturity template 200 may include a documentation summary 206 that lists key operational documents that are associated with one or more business commodities. In this example, in addition to the operational maturity overview 200 document itself, twenty-four other operational documents (generally titled “Document A” through “Document X”) are considered “key” operational documents for business commodities within the example business. Some, if not all, of the operational documents that populate the documentation summary 206 contribute in some form to the operational maturity score 212 that is computed.

In one embodiment, the mere existence of the document listed is the sole contributing factor to the operational maturity score 212. For instance, included in the documentation summary 206 is a field 208 that informs whether the operational document exists and is “on file.” In a simplified example, if ten documents are identified as “key” documents, the operational maturity score could simply be computed as ten points for each operational document that is on file. Thus, if nine of ten operational documents identified had been created, the operational maturity score would be 90 (assuming a maximum of 100).

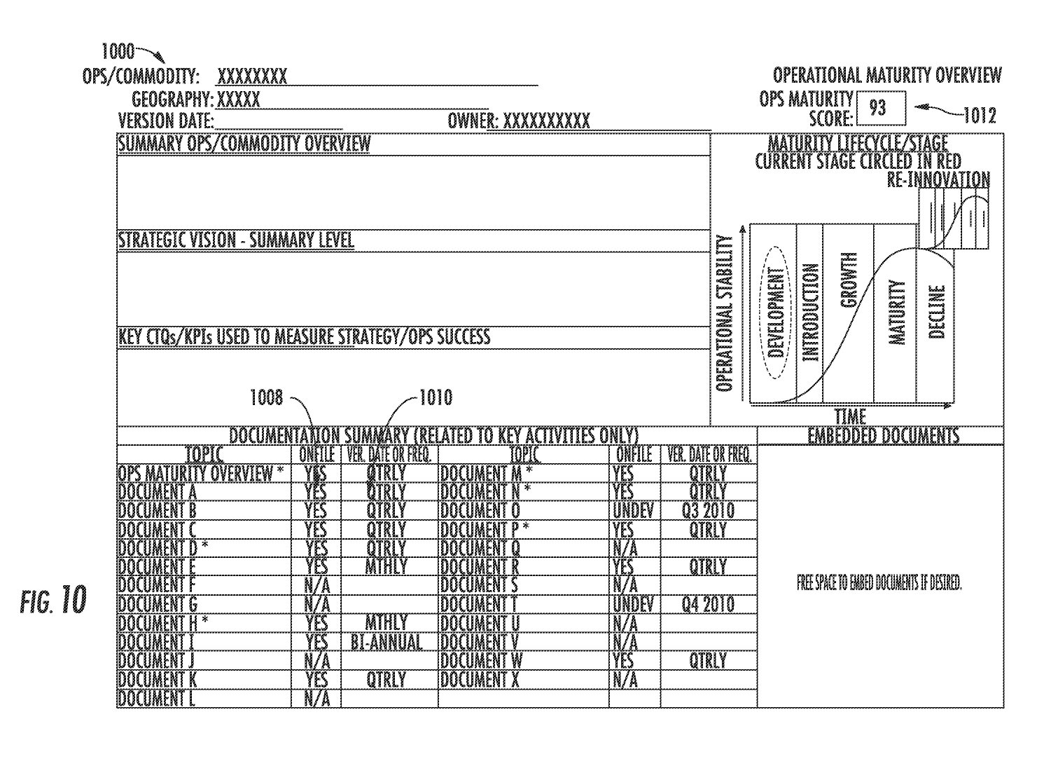

Of course, some operational documents may not apply to all business commodities. Referring to FIG. 10, another sample operational maturity template 1000 is illustrated and includes values inputted for whether the operational document is on file 1008 and the version date or update frequency 1010. As shown, numerous documents in this example are “not applicable” (N/A) to this example commodity. To penalize the operational maturity score 1012 for the non-existence of operational documents that are not applicable to the commodity, would generally be detrimental to the integrity of the entire evaluation of operational maturity. Thus, operational documents that are “not applicable” will generally receive “credit” in computing the operational maturity score 1012 as if the document existed. This practice serves to normalize the operational maturity scores across each business commodity. Generally speaking, no core required documents (e.g., the documents denoted with “*” in the example embodiments of FIG. 2 and FIG. 10) would be “not applicable” to any commodity.

Additionally, as shown in FIG. 10, the operational documents are listed as “Yes,” “No,” “N/A,” and “UnDev” in the on file field 1008. “Yes” and “No” are self explanatory as an indication of whether or not the document is on file. As noted above, “N/A” accounts for instances in which the particular document is not applicable to the commodity. Other categories may be included as needed to properly account for the business environment. Thus, “UnDev,” denoting that the document is currently “under development” is one such category. Oftentimes, the operational documents take long periods of time to properly develop. Thus, documents that are under developed should not receive operational maturity “credit” to the extent that fully developed documents are created for other commodities. In one embodiment, “UnDev” documents receive the same credit as “No” documents. However, in other embodiments “UnDev” documents receive some credit in the operational maturity score 1012, but not “full credit” afforded to “Yes” documents.

Furthermore, referring now back to FIG. 2, while the operational documents in the documentation summary 206 may receive equal weighting, in most practical applications the operational documents are weighted in terms of their perceived importance to the overall management of the commodity. For instance, core required documents may receive a greater weight in the operational maturity score than other operational documents. Conversely, because the core required documents are, by their nature, “required” they may receive less weight or no weight at all in the operational maturity score. However, in some embodiments, including those in which the existence of core required documents do not raise the operational maturity score 212, if one or more core required documents are missing, the operational maturity score 212 may be affected negatively by being assessed a penalty reduction in the operational maturity score 212.

The operational maturity score 212 may be automatically computed by a computing processor upon the manual entry by a user of the determination of whether the operational documents exist and are on file 208. In some embodiments, however, the operational maturity template 200 may be configured to automatically ping the business system 108 to determine whether each operational document listed in the documentation summary 206 is present on the system and automatically populate the on file field 208. Furthermore, the operational maturity template 200 may be further configured to access and auto-populate other data such as the version date or update frequency 210. In such embodiments, the operational maturity score may be automatically updated “in real time” as the operational documents are created and placed on file. Such features assist in ensuring that the operational maturity score 212 is accurate as it minimizes user error.

As discussed above, the operational maturity score 212 may be entirely dependent upon whether operational documents exist. However, such a system for determining the operational maturity scores 212 may be flawed in the instances in which some business commodities are run or managed more optimally than others. For instance, a commodity in which, for example, an operational risk profile 600 is completed, but done so poorly that numerous obvious risks were not identified and mitigated, arguably the commodity should not receive optimum “credit” in the operational maturity score as compared to a commodity in which an operational risk profile 600 has been diligently created. Thus, in some embodiments, the operational maturity template 200 is configured to ping each operational document file in an attempt to assess the quality of the document.

Quality of each document may be assessed by any number of ways. For instance, the presence or absence of predetermined key words within the document, the physical quantity of information within the document, or the file size of the document may be utilized to determine the “quality” of the document. Such “quality” may be assessed automatically by the system pinging the documents, or, alternatively, a user or business leader may manually inspect each document to determine the quality and input values for the quality of each document into the operational maturity template 200. If it is determined that the quality of the document does not reach predetermined goals, the credit for the document may be reduced or all together negated in the operational maturity score 212.

Furthermore, in some embodiments, the version date or update frequency 210 of the operational document affect the operational maturity score 212. For instance, a document that is out of date may not receive as much credit (or any at all) towards the operational maturity score 212 as a document that has been properly maintained and updated.

The operational maturity score 212 may not be completely dependent upon simply documentation data, although, documentation data will necessarily be a large component of the scoring. Without intending to be limited by theory, it is believed that the more documentation data available for a commodity and the better the quality of the documentation data, the stability of the commodity will be improved as business leaders are more fully informed and capable of minimizing foreseeable problems (and thus, being more operationally mature). The operational maturity score 212 may include a minor portion that is not dependent upon documentation data. Some examples of items that may alter the operational maturity score may include commodity financials, commodity staffing (e.g., overstaffed, understaffed, training level, etc.), facilities, etc.

Additionally, the operational maturity score 212 is not limited to any particular range of values or whole numbers. In some embodiments, the operational maturity score ranges from 0-100, but may be customized to the range desired by the business that implements the system.

As illustrated in FIG. 2, the operational maturity template may further include a determination for the maturity lifecycle stage 214. Generally, in most embodiments, this is a subjective determination by a business leader or commodity manager of where the commodity presently stands in its “lifecycle.” Making a determination of the commodity lifecycle stage 214 may assist business leaders in properly evaluating the obtained operational maturity score 212 as business leaders may find a score acceptable for a commodity in the “development” stage which may be unacceptable for a commodity in the “maturity” stage. Thus, identifying a lifecycle stage may assist business leaders in assessing which commodities need further attention.

Businesses may, of course, define the lifecycle stages as needed. In one embodiment, the lifecycle stages include “Development,” “Introduction,” “Growth,” “Maturity,” “Decline,” and “Re-Innovation.” A “Development” stage would be akin to a commodity in which operational activities have not begun. Generally, initial strategies, defining options, and organizational and/or operational design are still being performed for commodities in this stage. The next stage, “Introduction,” would be for commodities in which operational activities are ongoing and being managed. In such commodities, generally formal ownership/policies may exist where applicable but the commodity is still young and being adopted/communicated. In the “Growth” stage, operational activities are increasing in volume, size, and/or scale. Full scale adoption is generally still on-going and being communicated to drive for greater adoption. The “Maturity” stage is for commodities in which operational activities are considered “business as usual.” Very little process, policy or geographic changes are required. In the “Decline” stage, operational activities begin to decrease in volume, size, and/or scale due to changes in need or adoption. Examples of events that may bring about “Decline” may be population shifts, business demand declining, competitive alternatives, executive decision to shut down or cease additional and/or existing activities, etc. “Re-Innovation” usually occurs at either the very end of “Growth,” during “Maturity,” or during “Decline” stages. “Re-Innovation” does not necessarily imply the adoption of the existing operational activities in new markets. Usually, “Re-Innovation”is focused on improving existing “Mature” activities to increase process efficiencies and cost/risk mitigation.

As noted above, generally, the determination of the commodity operational maturity lifecycle stage is a subjective determination made by the user. Such practice takes advantage of the expertise of the user in evaluating the true lifecycle stage in which the commodity resides. However, in some embodiments, the maturity lifecycle stage may be automatically determined. For instance, the operational maturity template may be configured to automatically ping the business computer system 108 to retrieve pertinent data such as the date in which the commodity first began activities (if any), the financials of the commodity over a period of time to assist in determining growth, stability, or decline in operational activities, the geographic adoption of the commodity, etc.

Business leaders may wish to compare the operational maturity evaluations of multiple (or all) business commodities. In such cases, it may be beneficial to produce comparison data of multiple commodities. For instance, a simple list of commodity names 202 and operational maturity scores 212 may be beneficial for a business leader to evaluate commodities that need further attention (if any). Furthermore, as noted above, the maturity lifecycle stage 214 determination may be beneficial in evaluating commodities against other commodities. Thus, in some embodiments, the comparison data for multiple commodities includes not only the operational maturity scores 212 for each commodity, but also the maturity lifecycle stage data to categorize similar staged commodities.

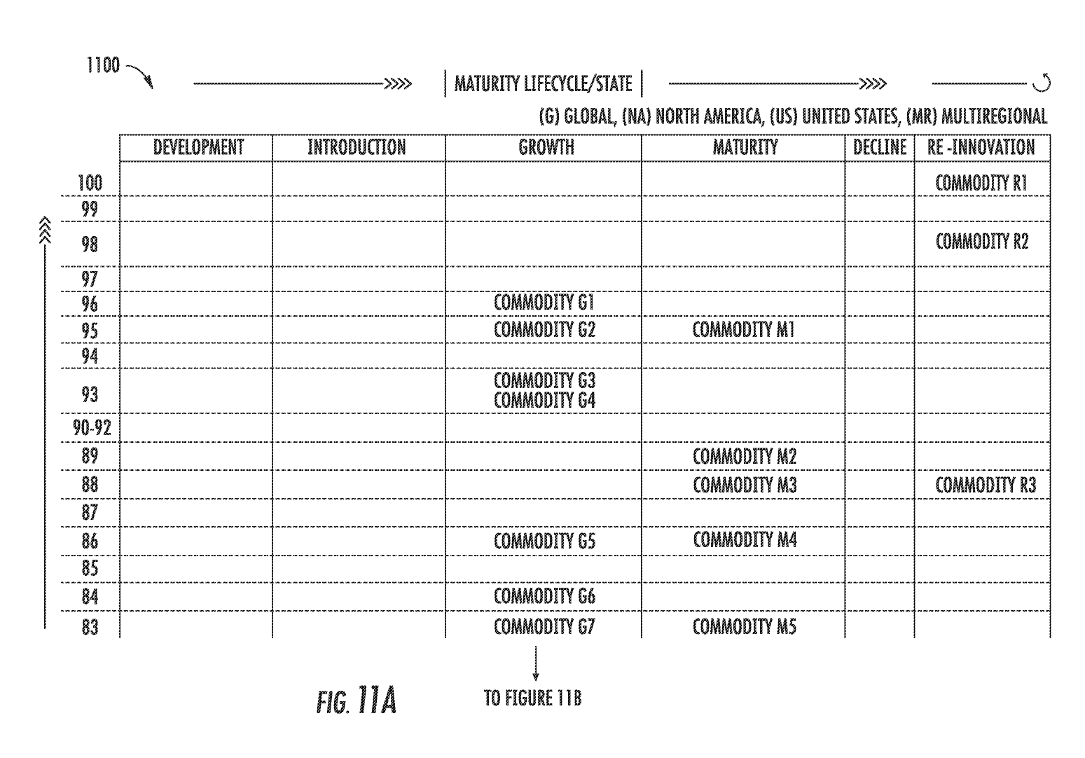

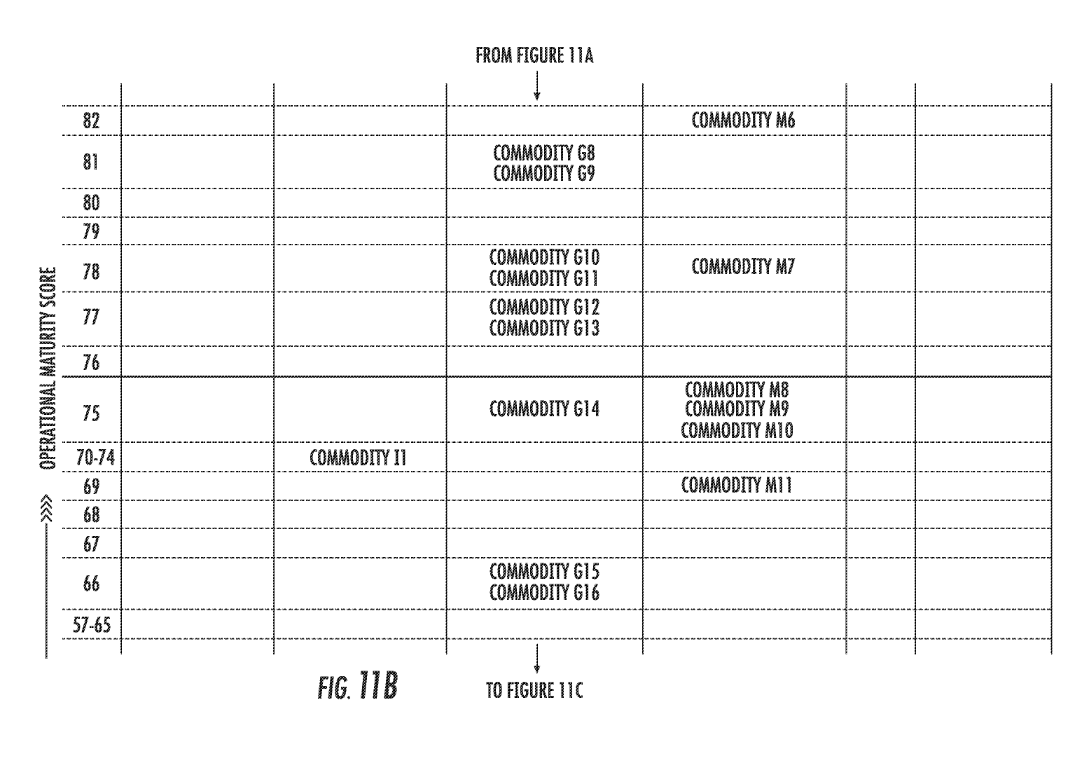

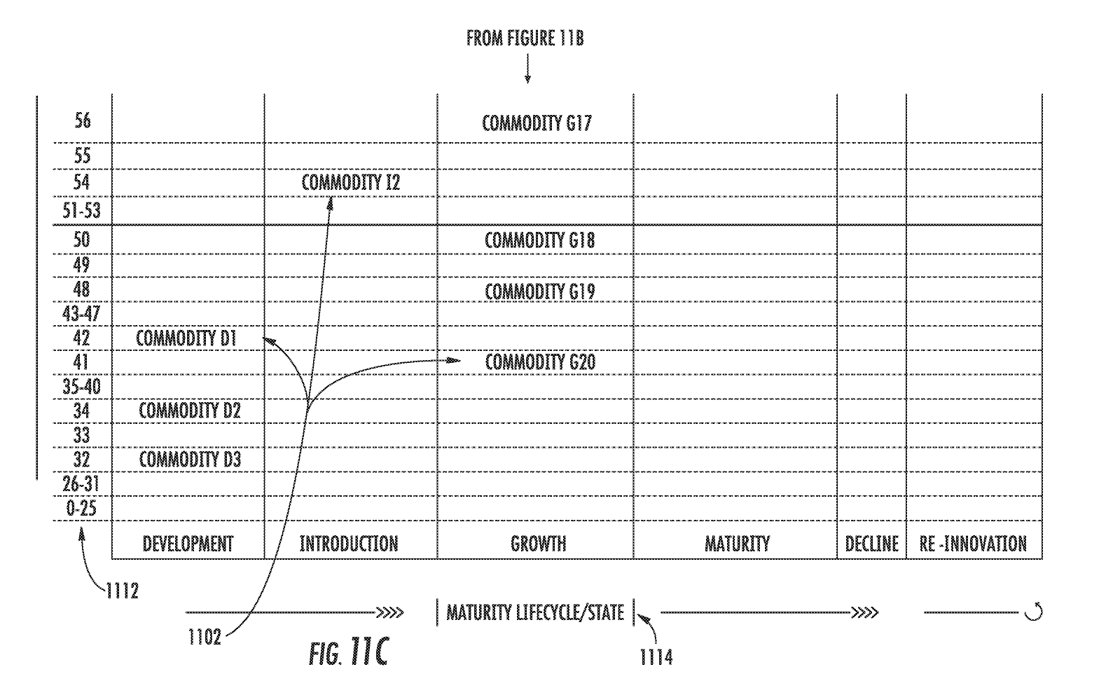

FIGS. 11A-11C illustrate one embodiment of a comparison of multiple commodities. The chart 1100 separates and categorizes the commodities based upon their operational maturity score 1112 and maturity lifecycle stage 1114. Such comparison data can be an extremely useful tool to business leaders to help readily identify what commodities are “mature” and commodities that need further attention. For instance, in the chart 1100, it can be seen that the operational maturity score for Commodity M1 is 95, while the operational maturity score for Commodity M11 is 69. As each commodity is categorized as being in the “Maturity” lifecycle stage, business leaders may readily single out Commodity M11 to inspect further to ensure business practices and policies are being properly followed to ensure a “mature” process. Conversely, Commodity D1, Commodity D2, and Commodity D3 are illustrated as yielding an operational maturity score of 42, 34, and 32 respectively. However, these commodities are noted as being in the “Development” stage, and thus, business leaders may not be nearly as concerned with low operational maturity scores of commodities in the “Development” lifecycle stage as they would be other commodities. Indeed, in this example, a business leader may find Commodity M11's score of 69 much more alarming than Commodity D3's score of 32.

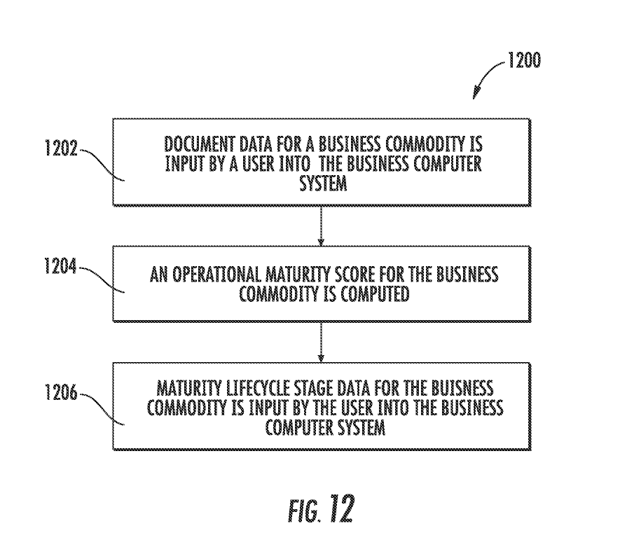

Referring now to FIG. 12, illustrated is a high level flow diagram 1200 of a method for evaluating the operational maturity of business commodities. At block 1202, a user 102 inputs documentation data for a business commodity into the business computer system 108. Of course, the user 102 does not necessarily have to enter the documentation data (or any other data) directly into the business computer system 102, but rather must simply input the data for eventual communication with the business computer system 102. For instance, the user may manually input into a computer application, such as, for instance, an operational maturity template 200 such as the example illustrated in FIG. 2, documentation data that may include data of whether one or more operational documents relating to the commodity has been created or additional data such as data indicating the last time one or more operational documents was updated, data indicating whether one or more documents are applicable for the commodity, or data indicative of the quality of the information within one or more operational documents.

At block 1204, an operational maturity score for the commodity is computed by the processor. As noted above, the documentation data provided may be weighted accordingly to account for the importance of the operational documents, the quality of the documents, etc. Additionally, at block 1206, the user makes a determination of the maturity lifecycle stage for the business commodity.

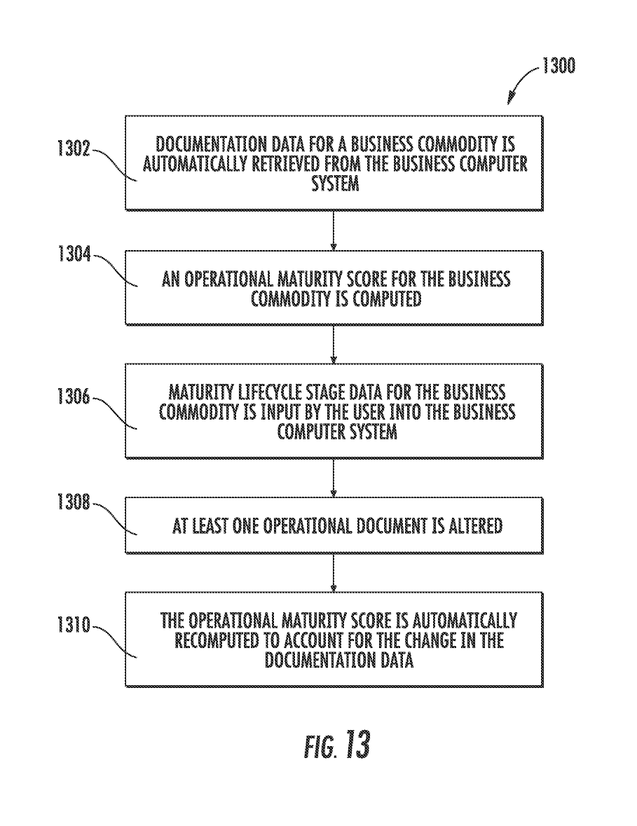

FIG. 13 provides a high level flow diagram 1300 of a more automated, “real time” method for evaluating the operational maturity of business commodities. At block 1302, documentation data for a business commodity is automatically retrieved from the business computer system 108. Again, the documentation data may include any type of data associated with the operational documents including, at least, whether the documents exist and are on file. This automatic retrieval of the documentation data allows for “real time” operational maturity score 212 updating as documents are created, removed, or otherwise altered and lessens the possibility of user error.

At block 1304, an operational maturity score for the commodity is computed by the processor. At block 1306, maturity lifecycle stage data for the business commodity is input by the user into the business computer system. Alternatively, as noted above, this method 1300, may be altered to automatically determine the maturity lifecycle stage 214 for the commodity if so desired by the business. For instance, data such as financial data and other data relating to the operation of the commodity may be automatically retrieved from the business computer system 108 and an algorithm implemented to automatically determine the maturity lifecycle stage 214.

At block 1308, at least one operational document is altered. Altering the document may include creating the document, deleting the document, updating the document, etc. As indicated above, with this method 1300 utilizing automatic retrieval of the documentation data and/or maturity lifecycle data, the operational maturity score 212 and/or maturity lifecycle stage 214 may be automatically recomputed to account for the change in the documentation data as illustrated at block 1310.

Thus, present embodiments herein disclosed provide for evaluating the operational maturity of business commodities. Documentation data is utilized to determine, at least in part, an operational maturity score for one or more business commodities. Furthermore, a determination of the maturity lifecycle stage of the commodity is also determined. In optional embodiments, comparison data may be produced to conveniently compare the operational maturity of a plurality of business commodities. The comparison data generally includes the operational maturity scores and, in some embodiments further includes the maturity lifecycle stage determination.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for evaluating operational maturity of business commodities, the system comprising:
a user interface;
a memory device;
a communication device; and
a processor operatively coupled to the communication device, user interface, and memory device, and configured to execute a computer-readable program code to:
receive documentation data associated with operational documents for a business commodity;
compute an operational maturity score for the business commodity based at least in part on the documentation data; and
receive maturity lifecycle stage data for the business commodity, wherein the operational maturity score, together with the maturity lifecycle stage data, provide an overall operational maturity evaluation for the business commodity.

2. The system of claim 1, further comprising a business computer system.

3. The system of claim 2, wherein the processor is further configured to execute the computer-readable program code to automatically receive the documentation data from a business computer system.

4. The system of claim 3, wherein the processor is further configured to execute the computer-readable program code to automatically recompute the operational maturity score for the business commodity when operational documents are updated or otherwise altered thus altering the documentation data.

5. The system of claim 4, wherein the operational maturity score is updated in real time when operational documents are updated or otherwise altered.

6. The system of claim 1, wherein the processor is further configured to execute the computer-readable program code to manually receive the documentation data as inputted by a system user.

7. The system of claim 1, wherein the documentation data comprises data indicating whether one or more operational documents relating to the business commodity have been created, are under development, have not been created, or are not applicable to the particular business commodity.

8. The system of claim 1, wherein the operational documents comprise core required documents.

9. The system of claim 8, wherein the documentation data relating to one or more of the core required documents is weighed greater in the computation of the operational maturity score than other operational documents.

10. The system of claim 1, wherein the processor is further configured to execute the computer-readable program code to receive information inputted by a user, the information relating to the business commodity.

11. The system of claim 10, wherein the information inputted by a user comprises a summary or overview of the business commodity, a strategic plan for the business commodity going forward, important critical-to-quality procedures for the business commodity, or combinations thereof.

12. The system of claim 1, wherein the maturity lifecycle stage data is a subjective determination determined and inputted by a user.

13. The system of claim 1, wherein the processor is further configured to execute the computer-readable program code to generate comparison data to compare the operational maturity of a plurality of business commodities.

14. The system of claim 13, wherein the comparison data is a chart or graph that includes maturity lifecycle stage data and/or the operational maturity score for each business commodity.

15. The system of claim 7, wherein the documentation data further comprises additional data, the additional data selected from the group consisting of data indicating the last time one or more operational documents was updated, data indicating the version of one or more operational documents, data indicating whether one or more documents are applicable for the business commodity, data indicating the quality of the information within one or more operational documents, and combinations thereof.

16. The system of claim 15, wherein the additional data comprises data indicating the quality of the information within one or more operational documents, the quality being determined by the presence or absence of predetermined key words or phrases within one or more operational documents, the amount of information within one or more operational documents, or file sizes of one or more operational documents.

17. A computer program product for evaluating the operational maturity of business commodities, the computer program product comprising at least one computer-readable medium having computer-readable program code portions embodied therein, the computer-readable program code portions comprising:
a first executable portion configured for receiving, through the use of a processor, documentation data associated with operational documents for a business commodity, wherein the processor is operatively coupled to the computer-readable program code, a user interface, a memory device, and a communication device;
a second executable portion configured for computing, through the use of the processor, an operational maturity score for the business commodity, the operational maturity score being based at least in part on the documentation data; and
a third executable portion configured for receiving, through the use of the processor, maturity lifecycle stage data for the business commodity, wherein the operational maturity score, together with the maturity lifecycle stage data, provide an overall operational maturity evaluation for the business commodity.

18. The computer program product of claim 17, wherein the first executable portion is further configured to automatically receive the documentation data from a business computer system.

19. The computer program product of claim 18, wherein the first executable portion is further configured to automatically recompute the operational maturity score for the business commodity when operational documents are updated or otherwise altered thus altering the documentation data.

20. The computer program product of claim 19, wherein the operational maturity score is updated in real time when operational documents are updated or otherwise altered.

21. The computer program product of claim 17, wherein the first executable portion is further configured to manually receive the documentation data as inputted by a system user.

22. The computer program product of claim 17, wherein the documentation data comprises data on whether one or more operational documents relating to the business commodity have been created, are under development, have not been created, or are not applicable to the particular business commodity.

23. The computer program product of claim 17, wherein the operational documents comprise core required documents.

24. The computer program product of claim 23, wherein the second executable portion is further configured to weigh one or more of the core required documents greater in the computation of the operational maturity score than other operational documents.

25. The computer program product of claim 17, further comprising a fourth executable portion configured to receive information inputted by a user, the information relating to the business commodity.

26. The computer program product of claim 25, wherein the information inputted by a user comprises a summary or overview of the business commodity, a strategic plan for the business commodity going forward, important critical-to-quality procedures for the business commodity, or combinations thereof.

27. The computer program product of claim 17, wherein the maturity lifecycle stage data is a subjective determination determined and inputted by a user.

28. The computer program product of claim 17, further comprising a fifth executable portion configured to generate comparison data to compare the operational maturity of a plurality of business commodities.

29. The computer program product of claim 28, wherein the comparison data is a chart or graph that includes maturity lifecycle stage data and/or the operational maturity score for each business commodity.

30. The computer program product of claim 22, wherein the documentation data further comprises additional data, the additional data selected from the group consisting of data indicating the last time one or more operational documents was updated, data indicating the version of one or more operational documents, data indicating whether one or more documents are applicable for the business commodity, data indicating the quality of the information within one or more operational documents, and combinations thereof.

31. The computer program product of claim 30, wherein the additional data comprises data indicating the quality of the information within one or more operational documents, the quality being determined by the presence or absence of predetermined key words or phrases within one or more operational documents, the amount of information within one or more operational documents, or file sizes of one or more operational documents.

32. A method for evaluating the operational maturity of business commodities, the method comprising:
receiving, via a computing device processor, documentation data associated with operational documents for a business commodity;
computing, via the computing device processor, an operational maturity score for the business commodity based at least in part on the documentation data; and
receiving, via the computing device processor, maturity lifecycle stage data for the business commodity, wherein the operational maturity score, together with the maturity lifecycle stage data, provide an overall operational maturity evaluation for the business commodity.

33. The method of claim 32, wherein the documentation data is automatically received from a business computer system.

34. The method of claim 33, further comprising automatically recomputing the operational maturity score for the business commodity when operational documents are updated or otherwise altered thus altering the documentation data.

35. The method of claim 34, wherein the operational maturity score is updated in real time when operational documents are updated or otherwise altered.

36. The method of claim 32, wherein the documentation data is manually inputted by a system user.

37. The method of claim 32, wherein the documentation data comprises data on whether one or more operational documents relating to the business commodity have been created, are under development, have not been created, or are not applicable to the particular business commodity.

38. The method of claim 32, wherein the operational documents comprise core required documents.

39. The method of claim 38, wherein the documentation data relating to one or more of the core required documents is weighed greater in the computation of the operational maturity score than other operational documents.

40. The method of claim 32, further comprising receiving information inputted by a user, the information relating to the business commodity.

41. The method of claim 40, wherein the information inputted by a user comprises a summary or overview of the business commodity, a strategic plan for the business commodity going forward, important critical-to-quality procedures for the business commodity, or combinations thereof.

42. The method of claim 32, wherein the maturity lifecycle stage data is a subjective determination determined and inputted by a user.

43. The method of claim 32, further comprising generating comparison data to compare the operational maturity of a plurality of business commodities.

44. The method of claim 43, wherein the comparison data is a chart or graph that includes the maturity lifecycle stage data and/or the operational maturity score for each business commodity.

45. The method of claim 37, wherein the documentation data further comprises additional data, the additional data selected from the group consisting of data indicating the last time one or more operational documents was updated, data indicating the version of one or more operational documents, data indicating whether one or more documents are applicable for the business commodity, data indicating the quality of the information within one or more operational documents, and combinations thereof.

46. The method of claim 45, wherein the additional data comprises data indicating the quality of the information within one or more operational documents, the quality being determined by the presence or absence of predetermined key words or phrases within one or more operational documents, the amount of information within one or more operational documents, or file sizes of one or more operational documents.
